(19) United States
(12) Patent Application Publication
(10) Pub. No.: US 2011/0187180 A1
(43) Pub. Date: Aug. 4, 2011

(54) HYDRAULIC BRAKING ARCHITECTURE FOR AIRCRAFT HAVING BRAKES WITH HALF-CAVITIES

(75) Inventor: David FRANK, Paris (FR)

(73) Assignee: MESSIER-BUGATTI, VELIZY VILLACOUBLAY (FR)

(21) Appl. No.: 13/019,787

(22) Filed: Feb. 2, 2011

(30) Foreign Application Priority Data
Feb. 3, 2010 (FR) 10 00447

(51) Int. Cl. B64C 25/44; B60T 11/28

(52) U.S. Cl. 303/2

(57) ABSTRACT

A hydraulic braking architecture for aircraft comprising a plurality of wheels fitted with brakes, each including two half-cavities, the architecture comprising:
a first braking circuit including servovalves, each powering one or more half-cavities on separate brakes; and
a second braking circuit including servovalves, each powering one or more half-cavities on separate brakes;
   both hydraulic circuits operating simultaneously in such a manner that on each brake, one of the half-cavities is powered by a servovalve of the first braking circuit, and the other half-cavity is powered by a servovalve of the second braking circuit, at least one of the half-cavities being powered by a servovalve that powers only said half-cavity.

The invention relates to a hydraulic braking architecture for aircraft having brakes with half-cavities.

### TECHNOLOGICAL BACKGROUND OF THE INVENTION

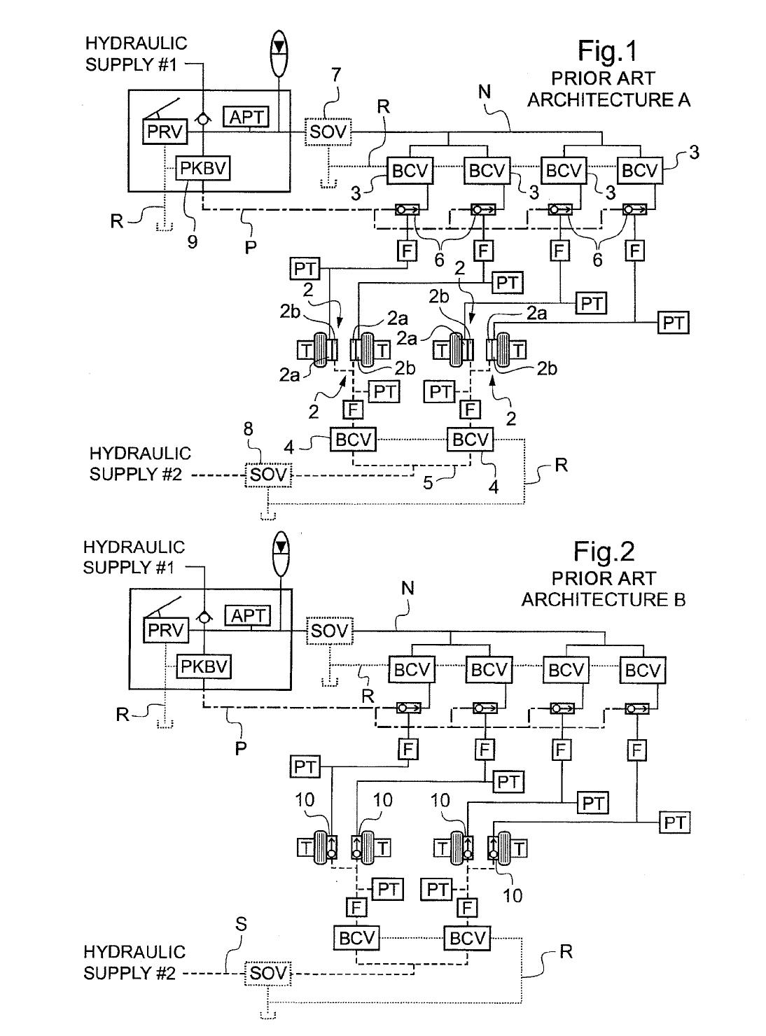

Various types of hydraulic braking architectures are known, according to whether the aircraft manufacturer is seeking to enhance the weight, the performance, the maintainability, or the availability of said architecture. Those various types of architecture are illustrated diagrammatically in FIGS. 1 to 4 for application to aircraft having four braked wheels.

A first type of architecture A, shown in FIG. 1, comprises two braking circuits, one of which is a normal circuit N (bold continuous lines) and the other an emergency circuit S (bold dashed lines). Each of the four brakes 2 includes two cavities 2a and 2b, each cavity being powered by only one of the braking circuits. The normal circuit N includes four valves 3, specifically in this example, servovalves or brake control valves (BCVs), each powering one of the cavities in each brake, specifically the cavity 2a. That disposition makes it possible to control each brake independently, and that contributes to minimizing the braking distance. The emergency circuit includes only two servovalves or BCVs 4, each powering two cavities 2b on two different brakes, thereby minimizing the cost and the weight of the emergency circuit, to the detriment however of the stopping distance when using the emergency circuit. The paired brake control does not enable the braking force to be optimized on each of the two wheels under consideration, but only on the “weaker” of the two. When one of the two wheels starts to slip, the shared servovalve lowers the braking force to both of the paired wheels.

The architecture further includes a parking circuit P (chain-dotted, bold) terminating on each brake at its cavity 2a, via a shuttle valve 6 organizing the connection of the cavity 2a either to the normal circuit N, or to the parking circuit P. The architecture also includes two return circuits R (dotted lines). The delivery of fluid to the normal circuit N, the emergency circuit S, and the parking circuit P is controlled by valves 7, 8, and 9.

In that architecture, the two cavities of each brake are independent and they are actuated in exclusive manner so as to avoid mixing the fluid from the normal circuit with the fluid from the emergency circuit, thereby having the advantage of avoiding maintenance tasks that could result in potential mixing of fluids coming from both circuits, but with this minimizing of maintenance effort being detrimental to the weight of the system, since each brake permanently has one cavity that is unused.

Such an architecture presents low sensitivity to failures, given that most of the components are redundant: two independent braking circuits that are suitable for delivering good braking performance (normal circuit) or slightly reduced braking performance (emergency circuit), each powering two independent brake cavities.

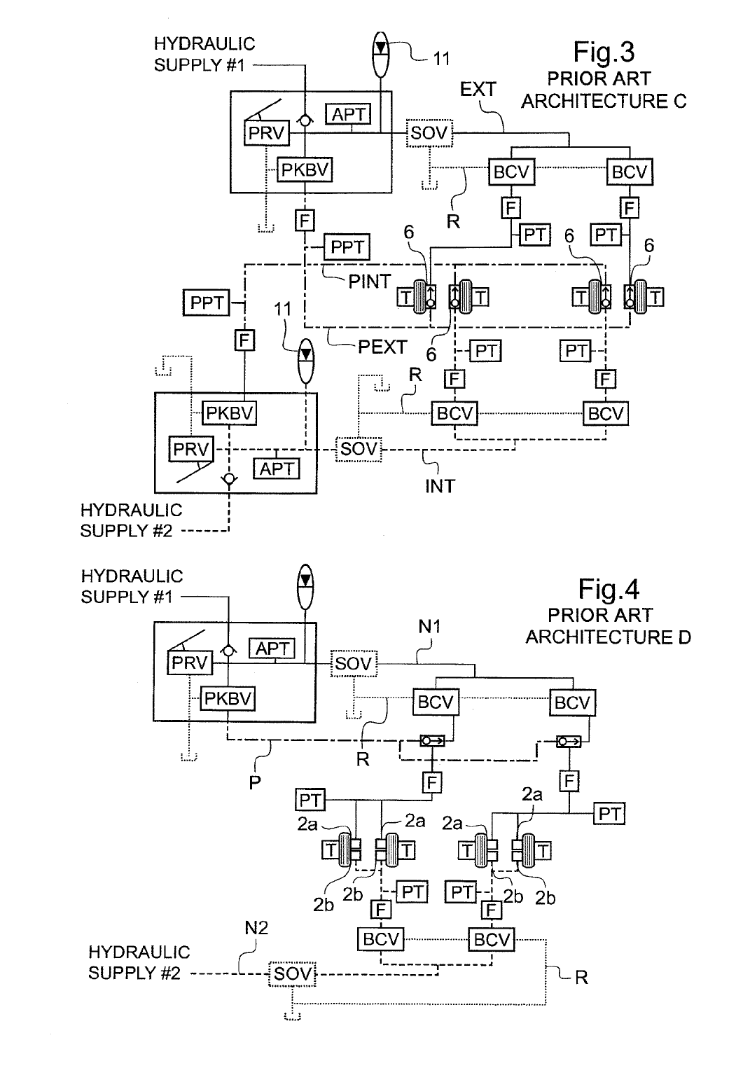

A second type of known architecture B is shown in FIG. 2. In this figure and in FIGS. 3 and 4, the elements shared by FIG. 1 are not given reference numbers for reasons of clarity. The circuits N, S, P, R are shown with the same types of lines. In the architecture illustrated in FIG. 2, each brake 2 includes a cavity that is powered alternatively either by the normal braking circuit or by the emergency braking circuit via shuttle valves 10. As in the above-described architecture, the normal circuit N has as many servovalves as braked wheels, whereas the emergency circuit S has only one servovalve per pair of wheels. Having only one cavity per brake makes it possible to optimize use of each brake, since said cavity is used in both the normal and the emergency circuits. However, the cavity is powered alternatively by one or the other of the braking circuits, in such a manner that transfers or mixing of fluid between the normal and the emergency circuits are likely to take place during each cycle of use of the architecture (in particular during functional tests before landing, and also depending on the order of starting and/or stopping of the engines. Such transfers or mixing of fluid give rise to regular maintenance tasks, in particular for rebalancing the hydraulic levels in the tanks of the aircraft, and also for preventing any risk of chemical pollution that may spread from one fluid to the other.

Finally, such an architecture presents sensitivity to failures that is a little higher than that of the above-described architecture, because of the use of a single braking cavity, and therefore of a common point (each shuttle valve 10) the failure of which prevents use of the entire brake.

A third known architecture C is shown in FIG. 3. In that architecture, each brake 2 includes only one cavity. The architecture comprises two identical hydraulic circuits that are activated simultaneously, each powering two brakes out of four (respectively an inner circuit INT powering the brakes of the inner wheels, and an outer circuit EXT powering the brakes of the outer wheels). There is therefore no risk of fluid being transferred between the circuits. In order to comply with certification rules, in particular the requirement that no single breakdown of any kind in the braking system should cause the braking distance to increase by 100% or more, the following provisions need to be considered during dimensioning of the hydraulic braking architecture:
The brakes need to be capable of absorbing double the nominal amount of energy in the event of one of the two braking circuits being unavailable, leading to a landing with only two braked wheels. That results in over-dimensioning of said brakes and consequently, an increase in their weight.
Each of the two braking circuits is generally provided with an accumulator, which is a piece of hydraulic equipment of relatively large weight compared with other equipment, so as to reduce the instances of breakdowns leading to the situation set out above (the most likely breakdown being loss of hydraulic generation of the aircraft).

In addition, the parking circuit is itself divided into two half-circuits Pext, Pint, acting on the same cavities respectively as the braking circuits EXT and INT, via shuttle valves 6. That division makes it necessary in particular to provide two accumulators 11 instead of one, and that increases the maintenance effort (checking the pressure of the accumulators) and the weight of the architecture.

Such an architecture presents considerable sensitivity to failures, given that it has no redundancy, neither in the braking circuit nor in the brakes themselves.

Finally, a fourth known architecture D is shown in FIG. 4. That architecture has the distinctive feature of comprising brakes 2, each including two half-cavities 2a, 2b. Each half-cavity is powered by a respective one of the two braking circuits N1 and N2. The two half-cavities are powered simultaneously. In this example, the term “half-cavity” rather than “double cavity” is used because said half-cavities are activated simultaneously, and might not suffice on their own to develop full braking force. The two half-cavities of each brake are independent, thus avoiding any mixing of fluid between the braking circuits.

In this example, each of the braking circuits N1 and N2 includes two servovalves, each powering two half-cavities on two separate brakes. That arrangement, although it increases weight, does not permit optimum wheel-by-wheel control of braking.

The two braking circuits N1, N2 are again identical in this example (except for the parking brake function that is often implemented on only one of the two circuits), each circuit has two servovalves, each powering two half-cavities on two separate brakes. Such an arrangement minimizes the weight of the braking system, to the detriment of braking performance.

Finally, such an architecture presents low sensitivity to failures, given that most of the components are redundant: two independent braking circuits, each powering two brake half-cavities (one per braked wheel), and each suitable for delivering a certain, although not optimum, level of braking performance, given the paired control of the brakes.

### OBJECT OF THE INVENTION

The invention aims to provide a new braking architecture offering a good compromise in terms of architecture weight, performance, availability, and reliability.

### BRIEF DESCRIPTION OF THE INVENTION

With a view to achieving this aim, provision is made for a hydraulic braking architecture for aircraft including a plurality of wheels fitted with brakes, each including two half-cavities, the architecture comprising:
a first braking circuit including servovalves, each powering one or more half-cavities on separate brakes; and
a second braking circuit including servovalves, each powering one or more half-cavities on separate brakes;

both hydraulic circuits operating simultaneously in such a manner that on each brake, one of the half-cavities is powered by a servovalve of the first braking circuit, and the other half-cavity is powered by a servovalve of the second braking circuit, at least one of the half-cavities being powered by a servovalve that powers only said half-cavity.

Thus, the principle of half-cavities in architecture D is conserved, thereby enabling the two hydraulic circuits to be totally independent. Both half-cavities are used simultaneously, but on each of the brakes, at least one of the half-cavities is controlled by a single servovalve, which makes it possible to provide optimized regulation of the braking of the wheel concerned, even when the other half-cavity is powered simultaneously with another half-cavity of another brake. Thus, it is possible to control braking in optimum manner, while using a reasonable number of servovalves.

### DETAILED DESCRIPTION OF EMBODIMENTS OF THE INVENTION

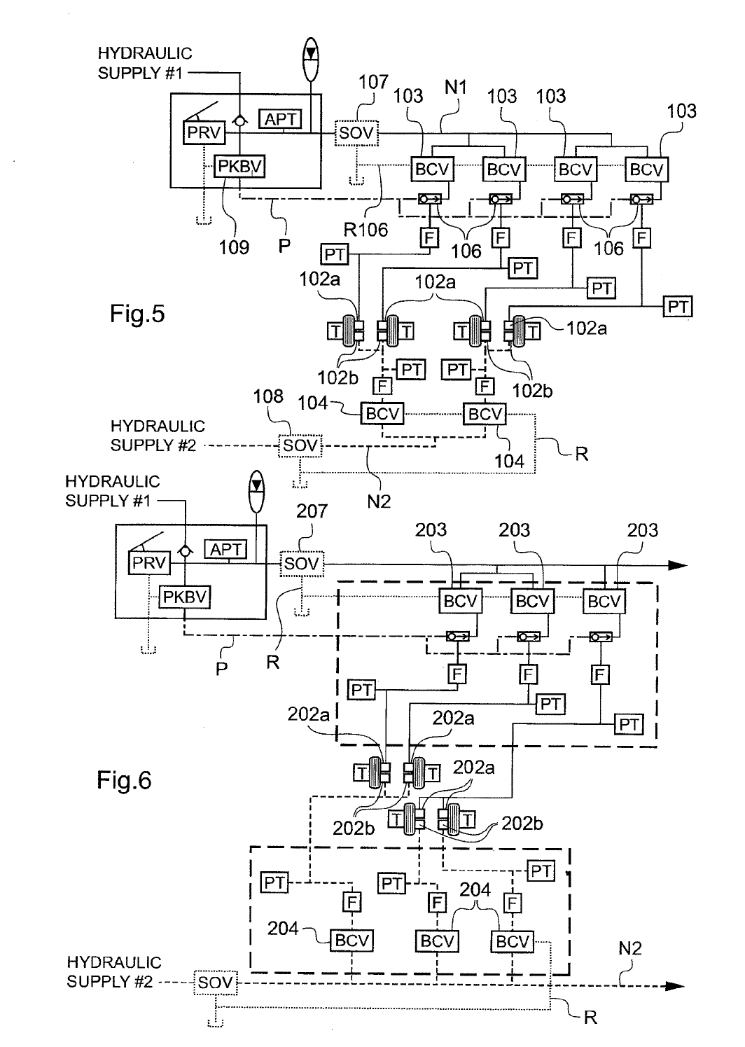

FIG. 5 is a diagram showing a first particular implementation of the invention, for application to an aircraft having four braked wheels.

References of elements that are shared with the other architectures are increased by 100. In this example each brake includes two half-cavities 102a and 102b.

The architecture comprises two hydraulic braking circuits N1 and N2, respectively powering the half-cavities 102a and 102b, and operating simultaneously.

The braking circuit N1 includes four servovalves 103, each powering only one of the half-cavities 102a. The braking circuit N2 includes only two servovalves 104, each powering two of the half-cavities 102b. Thus, and in accordance with the invention, on each of the brakes, at least one of the half-cavities is powered by a servovalve powering said half-cavity only, so that it is possible to optimize braking wheel by wheel. The architecture includes a parking circuit P associated with the same hydraulic power supply as the braking circuit N1 and powering the same half-cavities 102a via shuttle valves 106. The architecture includes isolation valves 107, 108, 109, in order to isolate respectively the braking circuit N1, the braking circuit N2, and parking circuit P. The architecture also includes two return circuits R for collecting the return fluid from the servovalves 103, 104.

In a variant shown in FIG. 6, the circuit N1 may include only three servovalves 203, two of which power a single respective half-cavity 202a, whereas the third servovalve powers two half-cavities 202a on two separate brakes. Thus, the circuit N1 comprises exactly the same amount of equipment as the circuit N2. It is advisable to ensure, in accordance with the invention, that on each brake, at least one of the half-cavities is powered by a servovalve that powers only said half-cavity. Thus, and as can be seen in FIG. 6, the two top wheels (e.g. the wheels carried by one of the main undercarriages) have brakes with respective half-cavities 202a, each of which is powered by a respective servovalve 203 of the circuit N1, while the corresponding other half-cavities 202b are both powered by a single servovalve 204 of the circuit N2. As for the bottom wheels (the wheels carried by the other main undercarriage), they have brakes with respective half-cavities 202b, each of which is powered by a respective servovalve 204 of the circuit N2, while the corresponding other half-cavities 202a are both powered by a single servovalve 203 of the circuit N1.

As suggested in FIG. 6, the provisions of the invention can easily be generalized for other configurations, e.g. an aircraft including eight braked wheels distributed over two main undercarriages. It is sufficient to consider that the four braked wheels shown in FIG. 6 are those of the left-hand undercarriage, and to reproduce the same pattern for the braked wheels of the right-hand undercarriage, the corresponding servovalves being connected to the same braking circuits N1 and N2.

What is claimed is:

1. A hydraulic braking architecture for aircraft including a plurality of wheels fitted with brakes, each including two half-cavities, the architecture comprising:
a first braking circuit including servovalves, each powering one or more half-cavities on separate brakes; and
a second braking circuit including servovalves, each powering one or more half-cavities on separate brakes;
both hydraulic circuits operating simultaneously in such a manner that on each brake, one of the half-cavities is powered by a servovalve of the first braking circuit, and the other half-cavity is powered by a servovalve of the second braking circuit, at least one of the half-cavities being powered by a servovalve that powers only said half-cavity.

2. A braking architecture according to claim 1, wherein for each brake, one of the half-cavities is powered by a servovalve that powers only said half-cavity, while the other half-cavity is powered by a servovalve powering said half-cavity and another half-cavity on another brake.

3. A braking architecture according to claim 1, comprising only a single parking circuit having a hydraulic power supply shared by one of the braking circuits, and powering only the half-cavities associated with said braking circuit.
